(19) United States
(12) Patent Application Publication
(10) Pub. No.: US 2003/0187720 A1
(43) Pub. Date: Oct. 2, 2003

(54) Vehicle allocating method, system and program

(75) Inventor: Yuji Takada, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/277,829

(22) Filed: Oct. 23, 2002

(30) Foreign Application Priority Data
Mar. 28, 2002 (JP) 2002-093187

(51) Int. Cl. G06F 17/60

(52) U.S. Cl. 705/10

(57) ABSTRACT

A population density degree information obtaining unit obtaining population density degree information, which indicates the number of people staying in an area peripheral to an arbitrary point, from a population density degree information management terminal, a weather information obtaining unit obtaining weather information, and weather information, which is forecast in the past, of the peripheral area from the weather information management terminal, and a vehicle allocation determining unit determining a vehicle to the point based on the population density degree information obtained by the population density degree information obtaining unit, and the weather information and the weather information forecast in the past, which are obtained by the weather information obtaining unit, are comprised, so that it becomes possible to provide a vehicle allocating method which can render a service for allocating a necessary vehicle to an appropriate place.

### BACKGROUND OF THE INVENTION

1. Field of the Invention

The present invention relates to a vehicle allocating method, system, and program optimally allocating a vehicle, and more particularly, to a vehicle allocating method, system and program which can grasp the status of a user, and can render a service allocating a necessary vehicle to an appropriate place in taxi and home-delivery service industries, etc. whose numbers of users vary according to weather conditions.

2. Description of the Related Art

Conventionally, in a taxi industry, scheduled vehicle allocation of empty taxi vehicles is performed especially at nighttime as part of an improvement in a passenger service by reducing the number of customers who wait for an empty vehicle, and an improvement in an operational rate and profitability by efficiently operating taxi vehicles. With the scheduled vehicle allocation, normally, an empty vehicle is preferentially forwarded to a taxi stand set up in a place congested with people, such as a busy street, a terminal station, etc.

However, there is no vehicle allocating system which predicts a place where people gather according to the contents of weather information, and issues a vehicle allocation instruction, or provides weather information and fare information, accepts a reservation, and improves the convenience of a user.

If weather is bad, people think of travel not on foot but by vehicle such as a taxi, etc. In this case, if a place where weather is bad or will become bad is learned, and if the place is learned to be congested with people, more people can use vehicles by quickly allocating vehicles to this place beforehand. So far, there is no method for comprehensively judging weather information and information of a place where people gather, and for allocating a vehicle. Therefore, it is difficult to improve the use efficiency of vehicles. Furthermore, a fare is uniform regardless of weather conditions, and there is no service for varying a fare according to weather information and weather conditions, and for accepting a reservation. Accordingly, it is difficult to differentiate among the characteristics of companies, and to meet a variety of user requirements.

### SUMMARY OF THE INVENTION

An object of the present invention is to provide a vehicle allocating method, system, and program which can grasp the status of a user by comprehensively judging weather information and information of a place where people gather, and can render a service allocating a necessary vehicle to an appropriate place in taxi and home-delivery service industries, etc., whose numbers of users vary according to weather conditions, in view of the above described background.

The vehicle allocating system according to the present invention is a vehicle allocating system which is connected to a population density degree information management terminal and a weather information management terminal via a network, and optimally allocates a vehicle. This system comprises a population density degree information obtaining unit, a weather information obtaining unit, and a vehicle allocation determining unit.

In a first aspect of the present invention, the population density degree information obtaining unit obtains, from the population destiny degree information management terminal, population density degree information that indicates the number of people staying in an area peripheral to an arbitrary point.

The weather information obtaining unit obtains, from the weather information management terminal, weather information at a certain time and weather information at the certain time, which is forecast in the past, of the peripheral area.

The vehicle allocation determining unit determines the allocation of the vehicle to the point based on the population density degree information obtained by the population density degree information obtaining unit, and the weather information at the certain time and the weather information at the certain time forecast in the past, which are obtained by the weather information obtaining unit.

### BRIEF DESCRIPTION OF THE DRAWINGS

FIG. 1 is a functional block diagram showing a vehicle allocating system to which the present invention is applied;

FIG. 2 is a schematic diagram for explaining the outline of a preferred embodiment according to the present invention;

FIG. 3 is a flowchart showing a vehicle allocation process to which the present invention is applied;

FIG. 4 shows operational procedures according to a preferred embodiment of the present invention;

FIG. 5 shows a data process according to the preferred embodiment of the present invention;

FIG. 6 shows a data process of a reservation, according to the preferred embodiment of the present invention;

FIG. 7 shows the configuration of the vehicle allocating system according to the present invention; and

FIG. 8 is a schematic diagram for explaining the loading of a vehicle allocation program according to the present invention into a computer.

### DESCRIPTION OF THE PREFERRED EMBODIMENTS

Hereinafter, a preferred embodiment according to the present invention is described with reference to the drawings.

The present invention adopts the following configuration in order to overcome the above described problems.

Namely, according to a preferred embodiment of the present invention, a vehicle allocating system of the present invention is a vehicle allocating system which is connected to a population density degree information management terminal and a weather information management terminal via a network, and optimally allocates a vehicle. This system comprises: a population density degree information obtaining unit obtaining, from the population density degree information management terminal, population density degree information which indicates the number of people staying in an area peripheral to an arbitrary point; a weather information obtaining unit obtaining, from the weather information management terminal, weather information at a certain time and weather information at the certain time, which is forecast in the past, of the peripheral area; and a vehicle allocation determining unit determining the allocation of the vehicle to the point based on the population density degree information obtained by the population density degree information obtaining unit, and the weather information at the certain time and the weather information at the certain time forecast in the past, which are obtained by the weather information obtaining unit.

With this configuration, a place and a time of rainfall can be learned, for example, according to weather information from a weather company. Therefore, vehicles are allocated to a place where a lot of people gather according to information of the current of people before a road or a station rotary is crowded with people due to a rainfall, whereby a service can be rendered to users timely. Additionally, if a rainy zone is in a suburb, long-distance travel is expected. Therefore, the number of vehicles is increased. If the rainy zone is in the center of a city, the number of users is small or a distance of using a vehicle is short. This is because different transportation means exist. Therefore, measures to decrease the number of vehicles, etc. can be taken, thereby efficiently allocating vehicles.

Additionally, in the vehicle allocating system according to the present invention, it is desirable that the vehicle allocation determining unit determines the allocation of vehicles the number of which is according to a product of the degree that obtained weather information at a certain time is worse than obtained weather information at the certain time forecast in the past, and the value of obtained population density degree information.

Furthermore, it is desirable that the vehicle allocating system according to the present invention further comprises a vehicle use information obtaining unit obtains the vehicle use information, which indicates an amount of time that the vehicle requires to arrive at the point, from a vehicle terminal comprised by the vehicle via the network, and the vehicle allocation determining unit determines the allocation of the vehicle in consideration of the vehicle use information obtained by the vehicle use information obtaining unit.

Still further, in the vehicle allocating system according to the present invention, it is desirable that the population density degree information obtaining unit comprises at least one of: a station user number information obtaining unit that predicts the number of people staying in an area peripheral to an arbitrary station based on the number of people who exit through an automatic ticket gate of the arbitrary station for a predetermined time period, and obtains the predicted number of people as population density degree information; a station user number information predicting unit that predicts the number of people who exit through an automatic ticket gate of an arbitrary station for a predetermined time period based on the number of people who enter through an automatic ticket gate of a different station other than the arbitrary station by using a recording medium which records a ticket attribute, and the ticket attribute, predicts the number of people staying in the area peripheral to the station based on the predicted number of people who exit, and obtains the predicted number of people staying in peripheral the area as population density degree information; an intra-base-station correspondent number information obtaining unit that predicts the number of people staying in an area peripheral to an arbitrary base station based on the number of correspondents who make a communication within the arbitrary base station for a predetermined time period, and obtains the predicted number of people as population density degree information; and an event spectator number information obtaining unit that predicts the number of people staying in an area peripheral to an arbitrary event site around a termination time of an event based on the termination time of the event at the arbitrary event site, and the number of spectators who gather for the event, and obtains the predicted number of people as population density degree information.

Still further, it is desirable that the vehicle allocating system according to the present invention further comprises a vehicle allocation information transmitting unit that transmits vehicle allocation information determined by the vehicle allocation determining unit to the vehicle terminal.

Still further, in the vehicle allocating system according to the present invention, it is desirable that the vehicle allocation information transmitting unit transmits a fare from the point to a different point, and weather information at an arrival time of the different point.

As a result, a user can also make a selection of being carried by a vehicle to the entrance of a home if it rains. Or, a user can get off a vehicle at a point immediately before the fare rises so as to save the fare on the way to a destination that can be reached on foot, if it is fine in the proximity of the destination. Namely, the user has an advantage of making a wider variety of selections. Since the number of people who use a vehicle increases in a rainy place, also a service rendering side has an advantage.

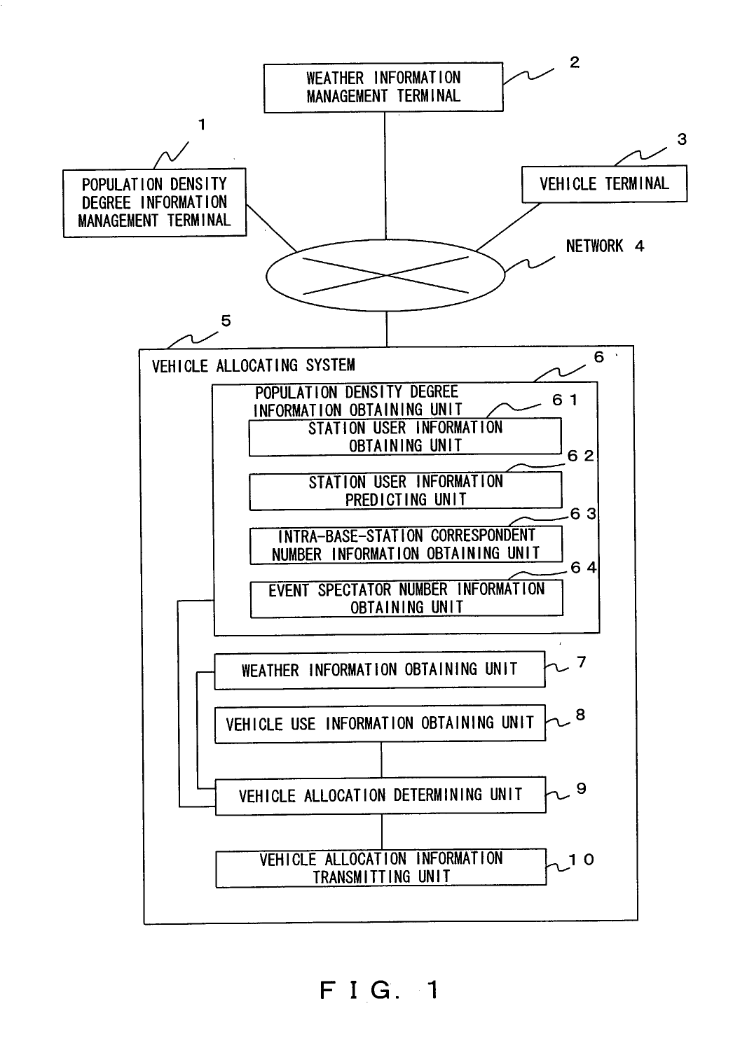

FIG. 1 is a functional block diagram showing a vehicle allocating system to which the present invention is applied.

In FIG. 1, a vehicle allocating system 5 is connected to a population density degree information management terminal 1 managing the use of a railway station, the use of a base station of a cellular phone company, the use of an event site, etc., a weather information management terminal 2 managing weather information, and a vehicle terminal 3 installed within a vehicle such as a taxi, a home-delivery vehicle, etc., via a network 4 such as the Internet, etc. This system comprises a population density degree information obtaining unit 6, a weather information obtaining unit 7, a vehicle use information obtaining unit 8, a vehicle allocation determining unit 9, and a vehicle allocation information transmitting unit 10.

The population density degree information obtaining unit 6 obtains population density degree information, which indicates the number of people who should stay in an area peripheral to an arbitrary place such as a station, an event site, a busy street, etc., from the population density degree information management terminal 1 via the network 4.

The weather information obtaining unit 7 obtains weather information at a certain time and weather information at a certain time, which is forecast in the past (for example, this morning), of the peripheral area from the weather information management terminal 2 via the network 4.

The vehicle allocation determining unit 9 determines the allocation of the vehicle to the place based on the population density degree information obtained by the population density degree information obtaining unit 6, and the weather information at the certain time and the weather information at the certain time forecast in the past, which are obtained by the weather information obtaining unit 7.

For example, the vehicle allocation determining unit 9 determines the allocation of vehicles the number of which is according to a product of the degree that the obtained weather information at the certain time is worse than the obtained weather information at the certain time, which is forecast in the past, and the value of the obtained population density degree information. Namely, if the obtained weather information at the certain time, which is forecast in the past, is “fine”, and the obtained weather information at the certain time is “rainy”, the degree of bad weather resultant from the comparison is made high. If the value of the obtained population density degree information is large, the product becomes large, so that vehicles the number of which is large is determined to be allocated in correspondence with the product.

The vehicle use information obtaining unit 8 obtains vehicle use information, which indicates the amount of time that the vehicle requires to arrive at the place, from the vehicle terminal 3 comprised by the vehicle via the network 4.

The vehicle allocation determining unit 9 determines the allocation of the vehicle in consideration of the vehicle use information obtained by the vehicle use information obtaining unit 8. Namely, the smaller the amount of time that the vehicle requires to arrive at the place, the higher the priority that the vehicle is allocated to the place. In contrast, the larger the amount of time, the lower the priority.

The population density degree information obtaining unit 6 comprises at least one of a station user information obtaining unit 61, a station user information predicting unit 62, an intra-base-station correspondent number information obtaining unit 63, and an event spectator number information obtaining unit 64.

The station user number information obtaining unit 61 predicts the number of people staying in an area peripheral to an arbitrary station based on the number of people who exit through an automatic ticket gate of the arbitrary station for a predetermined time period, and obtains the predicted number of people as population density degree information. Namely, if the number of people who exit through an automatic ticket gate of the same station for a short time period is large, a lot of people can be predicted to stay on the periphery of the station.

The station user number information predicting unit 62 predicts the number of people who exit through an automatic ticket gate of an arbitrary station for a predetermined time period based on the number of people who enter through an automatic ticket gate of a different station other than the arbitrary station by using a recording medium which records a ticket attribute, and the ticket attribute, predicts the number of people staying in an area peripheral to the station based on the predicted number of people who exit, and obtains the predicted number of people staying in the peripheral area as population density degree information. Namely, if a person enters through an automatic ticket gate by using a commuter pass for using a particular section, a magnetic ticket on which a use history is recorded, or the like, a station where the person should get off with high probability, and the number of people who exit from the station can be predicted. Consequently, the number of people staying on the periphery of the station where the people should get off can be predicted according to the above predictions.

The intra-base-station correspondent number information obtaining unit 63 predicts the number of people staying in an area peripheral to an arbitrary base station based on the number of correspondents who make a communication within the arbitrary base station for a predetermined time period, and obtains the predicted number of people as population density degree information. Namely, if the number of terminals (in other words, the number of correspondents) that make a communication almost at the same time is large in the same base station of a cellular phone or a PHS (Personal Handyphone System: simplified cellular phone), a lot of people can be predicted to stay on the periphery of the base station.

The event spectator number information obtaining unit 64 predicts the number of people staying in an area peripheral to an arbitrary event site around a termination time of an event based on the termination time of the event at the arbitrary event site, and the number of spectators who gather for the event, and obtains the predicted number of people as population density degree information. Namely, the number of people staying on the periphery of, for example, a concert site or a baseball ground around a scheduled (predicted) termination time based on the scheduled termination time of a concert at the concert site or a professional baseball game in the baseball ground, and the number of spectators who gather for the concert or the baseball game.

The vehicle allocation information transmitting unit 10 transmits the vehicle allocation information determined by the vehicle allocation determining unit 9 to the vehicle terminal 3 via the network 4. Additionally, the vehicle allocation information transmitting unit 10 transmits the fare from the place to a desired destination, and weather information at the destination at an arrival time of the destination to the vehicle terminal 3 via the network 4.

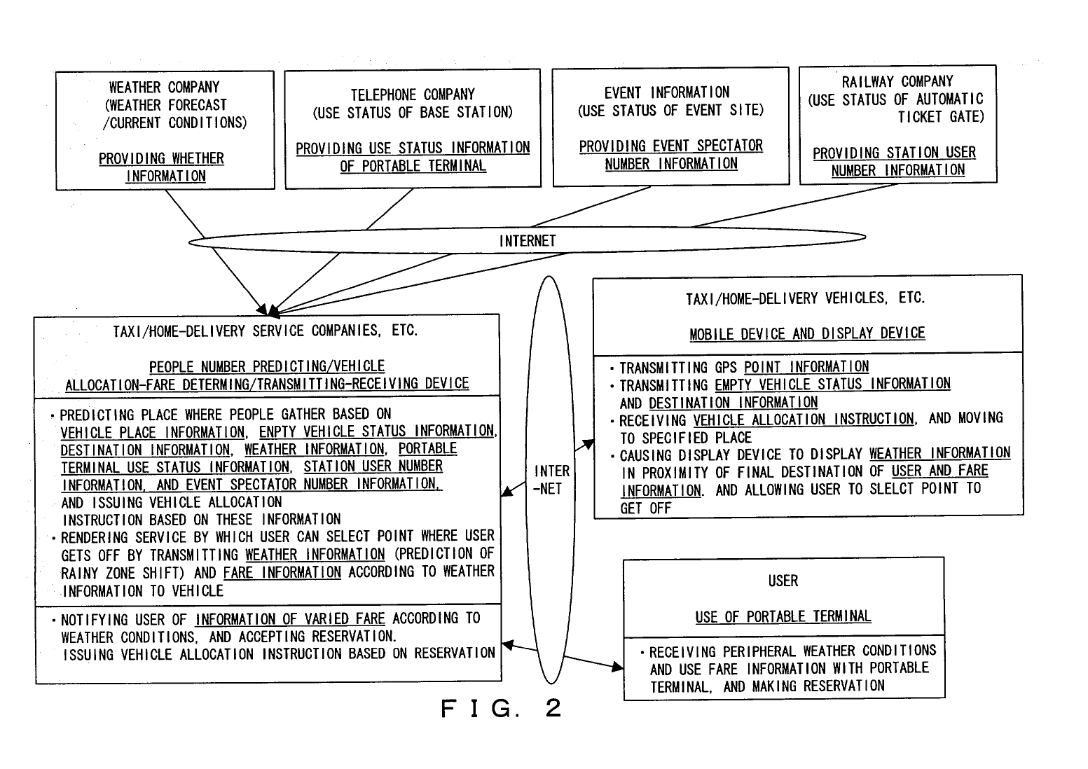

FIG. 2 is a schematic diagram for explaining the outline of a preferred embodiment according to the present invention.

In FIG. 2, a people number predicting/vehicle allocation-fare determining/transmitting-receiving device (corresponding to the vehicle allocating system 5) is connected to a weather company (corresponding to the weather information management terminal 2), a telephone company (corresponding to the population density degree information management terminal 1), and a railway company (also corresponding to the population density degree information management terminal 1) via the Internet (corresponding to the network 4). Additionally, the people number predicting/vehicle allocation-fare determining/transmitting-receiving device is also connected to a mobile device and a display device (corresponding to the vehicle terminal 3), which are installed within a taxi or a home-delivery vehicle, via the Internet. Furthermore, the people number predicting/vehicle allocation-fare determining/transmitting-receiving device is also connected to a mobile phone possessed by a general user via the Internet.

The people number predicting/vehicle allocation-fare determining/transmitting-receiving device determines the allocation of a vehicle based on weather information provided from the weather company, portable terminal use status information provided from the telephone company, station user number information provided from the railway company, and vehicle data received from the mobile device, and transmits the determined information to the mobile device comprised by the vehicle via the Internet.

The vehicle then moves to a specified place based on the received information. If the vehicle is a taxi, it can carry a customer. If the vehicle is a home-delivery vehicle, a package of a customer can be carried.

Additionally, the people number predicting/vehicle allocation-fare determining/transmitting-receiving device transmits weather information and fare information so that anybody can freely view the information on the Internet. Therefore, a user can also obtain the information, and reserve a ride by using a portable terminal.

Furthermore, for a user of the vehicle, weather information in the proximity of a final destination and a fare to the proximity of the final destination are displayed on the display device based on the final destination of a user, so that the user can select a point to get off. As a result, the user can get off before the final destination if it is fine, thereby saving the fare.

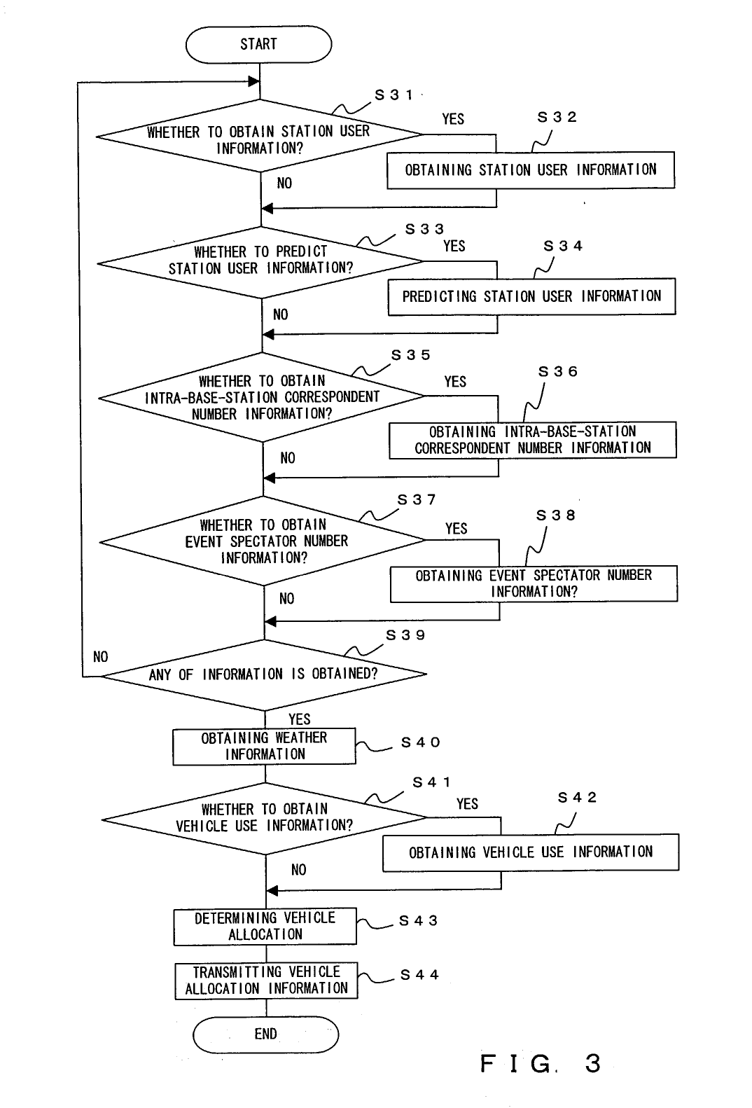

FIG. 3 is a flowchart showing a vehicle allocation process to which the present invention is applied.

Firstly, in step S31, it is determined whether or not to obtain station user information. If it is determined to obtain the station user information (“YES”), the number of people who exit through an automatic ticket gate of an arbitrary station for a predetermined time period is received from the population density degree information management terminal 1 via the network 4, the number of people staying in an area peripheral to the station is predicted based on the received number, and the predicted number is obtained as population density degree information in step S32.

In step S33, it is determined whether or not to predict station user information. If it is determined to predict the station user information (“YES”), the number of people who enter through an automatic ticket gate of a different station other than the arbitrary station by using a recording medium which records a ticket attribute, and the ticket attribute are received from the population density degree information management terminal 1 via the network 4, the number of people who exit through the automatic ticket gate of the arbitrary station for the predetermined time period is predicted based on the received data, the number of people staying in an area peripheral to the station is predicted based on the predicted number of people who exit, and the predicted number of people is obtained as population density degree information in step S34.

In step S35, it is determined whether or not to obtain an intra-base-station correspondent number information. If it is determined to obtain the intra-base-station correspondent number (“YES”), the number of correspondents who make a communication within an arbitrary base station for a predetermined time period is received from the population density degree information management terminal 1 via the network 4, the number of people staying in an area peripheral to the base station is predicted based on the received number, and the predicted number is obtained as population density degree information in step S36.

In step S37, it is determined whether or not to obtain event spectator number information. If it is determined to obtain the event spectator number information (“YES”), the termination time of an event at an arbitrary event site and the number of spectators who gather for the event are received from the population density degree information management terminal 1 via the network 4, the number of people staying in an area peripheral to the event site around the termination time is predicted based on the received data, and the predicted number is obtained as population density degree information in step S38.

Then, in step S39, it is determined whether or not population density degree information has been obtained in any of the steps S32, S34, S36, and S38. If the population density degree information has been obtained in any of the steps (“YES”), the flow proceeds to the next step. Otherwise (“NO”), the flow returns to step S31, and the above described steps are repeated until the population density degree information is obtained.

Next, in step S40, weather information at a certain time and weather information at the certain time, which is forecast in the past, of the peripheral area are obtained from the weather information management terminal 2 via the network 4.

In step S41, it is determined whether or not to obtain vehicle use information. If it is determined to obtain the vehicle use information (“YES”), vehicle use information which indicates the amount of time that the vehicle requires to arrive at the place is obtained from the vehicle terminal 3 comprised by the vehicle via the network 4 in step S42.

In step S43, the vehicle is determined to be allocated in consideration of the vehicle use information obtained by the vehicle use information obtaining unit 8. Namely, the smaller the amount of time that the vehicle requires to arrive at the place, the higher the priority that the vehicle is allocated to the place. In contrast, the larger the amount of time, the lower the priority.

Details of the determination of vehicle allocation will be described later.

Lastly, in step S44, the vehicle allocation information determined by the vehicle allocation determining unit 9 is transmitted to the vehicle terminal 3 via the network 4.

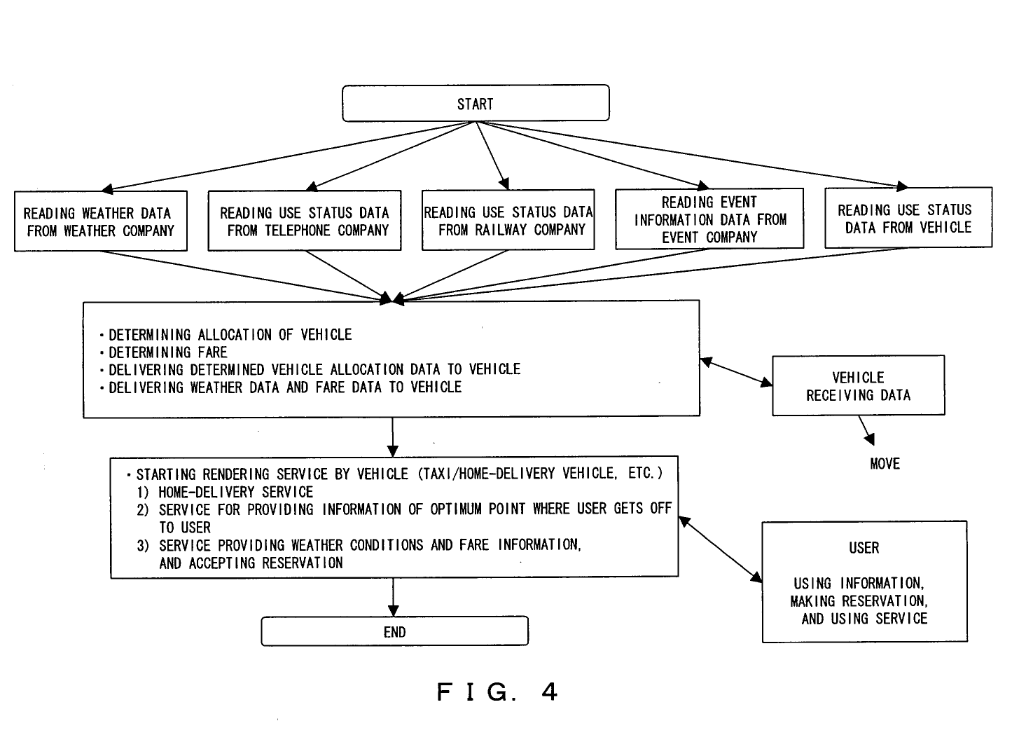

FIG. 4 is a schematic diagram showing the operational procedures according to the preferred embodiment of the present invention.

The vehicle allocating system 5 obtains at least any of the weather data from the weather company, the use status data from the telephone company, the use status data from the railway company, and the use status data from the event company, etc., further obtains the use status data from the vehicle, determines the allocation of the vehicle based on these data, and also determines a fare. Then, the vehicle allocating system 5 transmits the determined data to the vehicle and the user, and starts a home-delivery service, or, for a taxi user, a service providing the information of an optimum point where the user should get off, a service providing weather conditions and fare information, and the like.

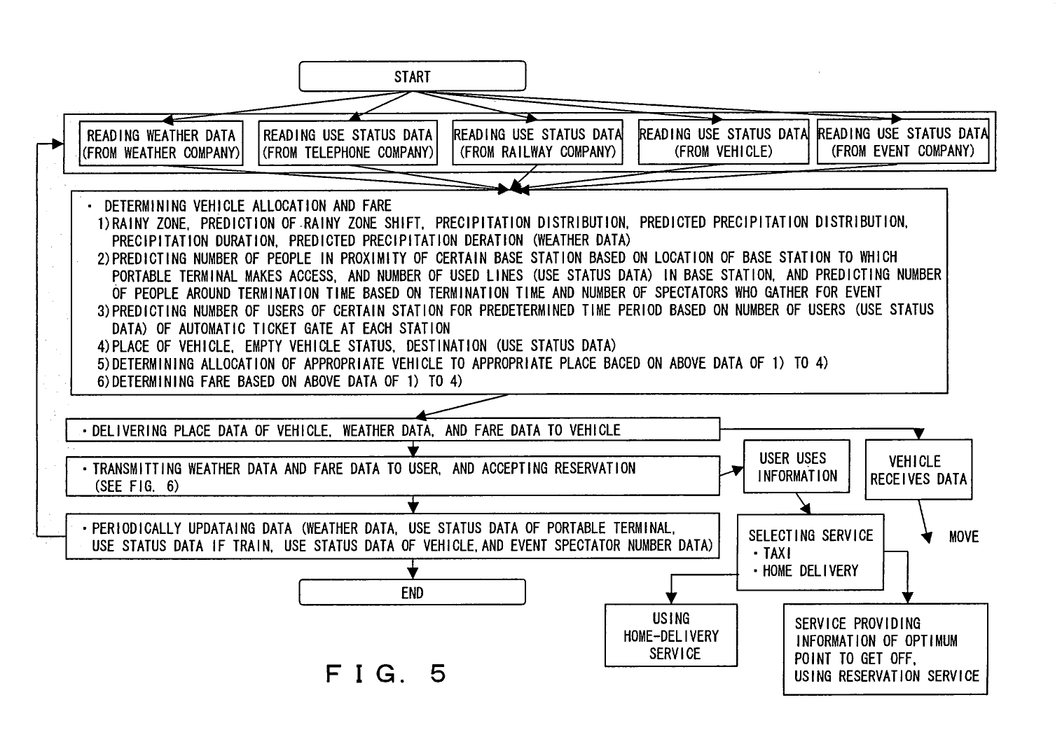

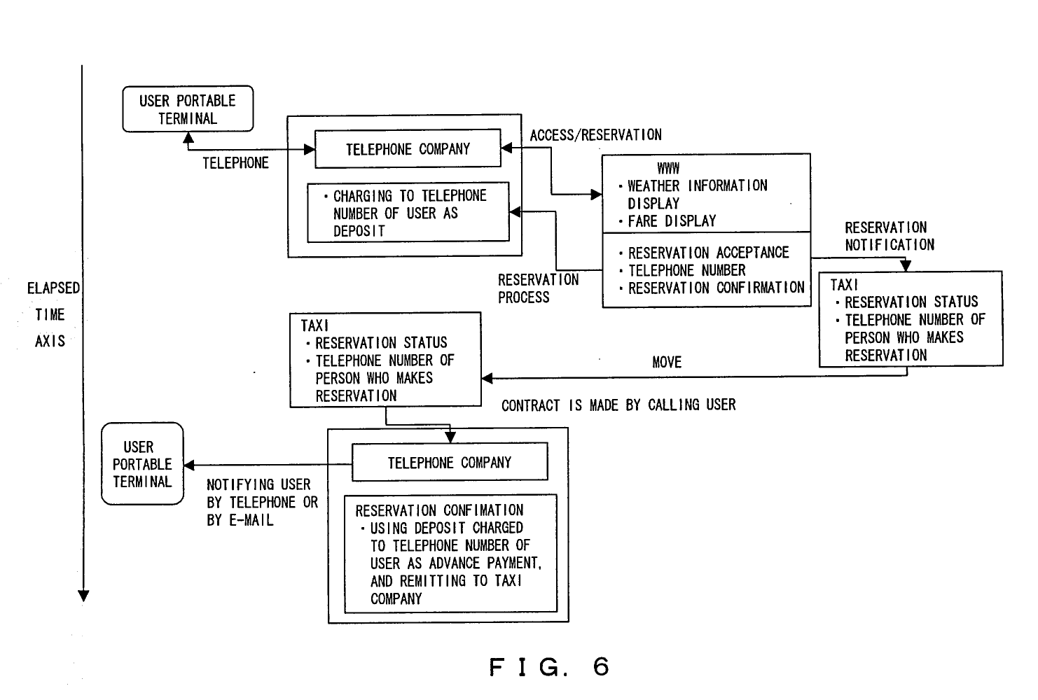

FIG. 5 shows a data process according to the preferred embodiment of the present invention, whereas FIG. 6 shows a data process for a reservation according to the preferred embodiment of the present invention.

The vehicle allocating system 5 predicts the number of users at each station based on weather data such as a rainy zone, a prediction of a rainy zone shift, a precipitation distribution, a predicted precipitation distribution, a precipitation duration, a predicted precipitation duration, etc., which are received from the weather information management terminal 2, use status data of a portable terminal, such as the location of a base station to which the portable terminal makes an access, the number of used lines in the base station, etc., and use status data such as the number of users of an automatic ticket gate at each station, etc., which are received from the population density degree management terminal 1, and use status data such as the place of a vehicle, the status of an empty vehicle, destination, etc., which are received from the vehicle terminal 3. The vehicle allocating system 5 then determines an allocation priority to each vehicle, determines a fare, and transmits and delivers the predicted and determined data to the vehicle and the user via the Internet (network 4). By periodically updating receive data, the most recent status is reflected on the predictions and the determinations.

The prediction of the number of users at each station can be implemented by using statistical information of the number of station users in a time zone, and by grasping the number of users. Additionally, the status of persons who pass through an automatic ticket gate at a station is monitored in real time, so that the number of users can be also obtained from the status data. Furthermore, the number of users can be obtained also with a method that is made public by Japanese Patent Publication No. 11-165637, which predicts an arrival time and the number of people of a different station according to the information of a commuter pass, a ticket, etc. of a person who passes through an automatic ticket gate of a certain station. Furthermore, a place where people gather, and the number of people are predicted based on the use status data of an event site, the location of a base station to which a portable terminal makes an access, and the use status data of a portable terminal, such as the number of used lines in the base station, also in consideration of the location of the event site in the proximity of the base station, the location of the station, etc.

The determination of a vehicle allocation priority to each vehicle is made according to the following function (equation 1), and notification is made to a target vehicle having higher priority via the Internet in descending order of priorities.

priority of a vehicle nm=F (weather conditions at a station m, status of a vehicle n, location status of the station m, the number of people m, whether weather forecast is either correct or incorrect, the amount of time that the vehicle n requires to arrive at the station m) (1)

This function (equation 1) has a characteristic such that a priority becomes higher as the amount of time that the vehicle n requires to arrive at the station m becomes smaller, a characteristic such that the priority becomes higher according to the location status of a station, such as the status that the station is in a suburb, or the like, if weather at the station is bad (a precipitation is high), and a characteristic such that the priority becomes higher if actual weather is worse than forecast. For example, the following equation 2 is considered as an equation having the above described characteristics.

priority of the vehicle nm=(weather conditions at the station m×status of the vehicle n×location status of the station m×the number of people m×whether weather forecast is either correct or incorrect)/(the amount of time that the vehicle n requires to arrive at the station m) (2)

priority of the vehicle nm: priority that an nth (n=1, 2, . . . , N) vehicle is allocated to an mth (m=1, 2, . . . , M) station

weather conditions at the station m: weather conditions at the station m (example: fine=0.05, low precipitation (drizzle, sprinkle)=0.1, medium precipitation=0.5, high precipitation (downpour)=1); obtained according to a precipitation distribution of a rainy zone, and the location of the station m

status of the vehicle n: use status of the vehicle n (example: being ridden (being used)=0, empty=1)

location status of the station m: If the station is in a suburb of a city, a travel distance is considered to become longer than in the case where the station is in the center of the city. Therefore, this value is made larger than that of a station located in the center of the city so that many vehicles are allocated (example: in the case where the station is in a suburb=1, in the case where the station is in the center of a city=0.5)

the number of people m: the number of people on the periphery (place where people gather) of the station m (example: a small number of people=0.1, a medium number of people=0.5, a large number of people=1) whether weather forecast is either correct or incorrect (example: correct=0.5, incorrect=1)

the amount of time that the vehicle n requires to arrive at the station m: the amount of time that the vehicle n arrives at the station m (example: within 5 minutes=0.1, 5 to 15 minutes=0.5, 15 minutes or more=1)

As is known from the above equation 2, if the amount of time that the vehicle n requires to arrive at the station m is small on the assumption that a numerator is constant, a denominator becomes small, and the value of the priority becomes large. Therefore, the vehicle n is allocated to the station m with high priority.

Additionally, if weather on the periphery of the station is bad (precipitation is high), the value of the priority becomes large according to the location status of the station. Accordingly, the vehicle n is allocated to the station m with high priority.

Furthermore, if weather forecast is incorrect, especially, if it rains although the weather forecast said that it would be fine, the value of the priority also becomes large. Therefore, the vehicle n is allocated to the station m with high priority.

Here, the most important factor among those of determining the priority of the vehicle nm is a product of the “weather conditions at the station m” and “whether weather forecast is either correct or incorrect”. Namely, if the “weather conditions at the station m” is “high precipitation”, and if “whether weather forecast is either correct or incorrect” is “incorrect”, in other words, if the degree that obtained weather information at a certain time is worse than obtained weather information at the certain time, which is forecast in the past, is high, the vehicle n is allocated to the station m with high priority.

Next, a method determining a fare of a taxi vehicle according to weather conditions is explained.

The vehicle allocating system 5 causes the display device within the vehicle to display predicted weather conditions at each point in the proximity of a destination, to which a fare (predicted according to a travel distance and a travel duration) is added, and a fare to each point according to weather data such as a rainy zone, a prediction of a rainy zone shift, a precipitation distribution, a predicted precipitation distribution, a precipitation duration, a predicted precipitation duration, etc., which are received from the weather information management terminal 2, and use status data of a destination of a vehicle, which is received from the vehicle terminal 3.

The predicted weather conditions at each point and the fare to each point are displayed on the display device within the vehicle as described above, so that a user can get off even before a destination in order to save the fare if the sky clears up.

Additionally, a discounted fare from a predicted fine zone can be presented on the display device, which makes a user feel relatively cheap, thereby promoting the use of a vehicle. The determination of a fine zone can be made according to the prediction data of a rainy zone shift, and at the timing when a windshield wiper of a vehicle stops if it clears up. Furthermore, with the fare discount, a final fare is discounted by reducing a unit fare, for example, 120 yen/km to 110 yen/km with the use of the predicted data of a rainy zone shift, and the timing when a windshield wiper stops as a trigger.

Furthermore, forecast information of weather conditions in the proximity of a station can be obtained by accessing the Internet with a portable terminal. In this case, for example, if weather forecast says that the sky clears up after 10 minutes, the use of a vehicle such as a taxi, etc. is expected to be reduced. This is because the number of people who judge to travel on foot after a while. On the vehicle (taxi) side, also discount rate information of a fare is notified on the Internet at the time of a rainfall so as to secure the number of users. In this way, attempts are made to secure the number of users.

The determination of a discount rate is made, for example, as follows.

Namely, if it is forecast to stop raining after ten minutes, a base fare is discounted by 10 percent so as to urge a person who will wait for the stop of a rainfall to use a vehicle. If it is forecast to stop raining after 20 minutes, the base fare is discounted by 5 percent so as to urge a person who will wait for the stop of a rainfall for 20 minutes to use a vehicle. If it is forecast to stop raining after 60 minutes, the fare is not discounted. This is because the number of people who wait for 60 minutes becomes small.

As described above, if a user can predict that a rainfall is a shower, a taxi company side can promote the use of a vehicle by varying a fare. Therefore, the user can use a vehicle at less cost. Since also the taxi company side can acquire a user, both the taxi company and the user sides have an advantage.

A reservation is accepted via the Internet as follows. In this case, a method temporarily charging a deposit to the telephone toll of a user when the user makes a reservation in order to confirm the intention of the reservation of the user is adopted. By way of example, a charge (for instance, 500 yen) is made as a telephone toll to the telephone number (IP address) of a portable terminal of the user. Accordingly, there is no need to transmit the information of a credit card number, etc. on the Internet, and a user can make a reservation without anxiety. Additionally, the taxi company side can confirm the use intention of the user, owing to the adoption of the mechanism for charging a deposit at the time of reservation. Therefore, both of the sides have an advantage. Furthermore, if a plurality of users who make a reservation exist, and if the directions of their destinations are the same, a taxi shared by the users can be also allocated, leading to efficient vehicle allocation.

Based on this reservation, reservation information is transmitted to a taxi vehicle. The taxi vehicle that receives the reservation information heads for the reservation site, and transmits a notification to the portable terminal of the user who makes the reservation by telephone or by e-mail when picking up the user, so that the reservation becomes a formal contract. A taxi fare from which the deposit is subtracted is finally charged to the user. An agreement such that the deposit is remitted to the side of the taxi company is made between the telephone company and the taxi company, and the fare is paid by the user as a telephone toll.

The preferred embodiment according to the present invention is described above with reference to the drawings. However, the vehicle allocating system to which the present invention is applied is not limited to the above described embodiment if its functions are implemented. Needless to say, the vehicle allocating system may be a single device, a system composed of a plurality of devices, an integrated device, or a system which performs processes via a network such as a LAN, a WAN, etc.

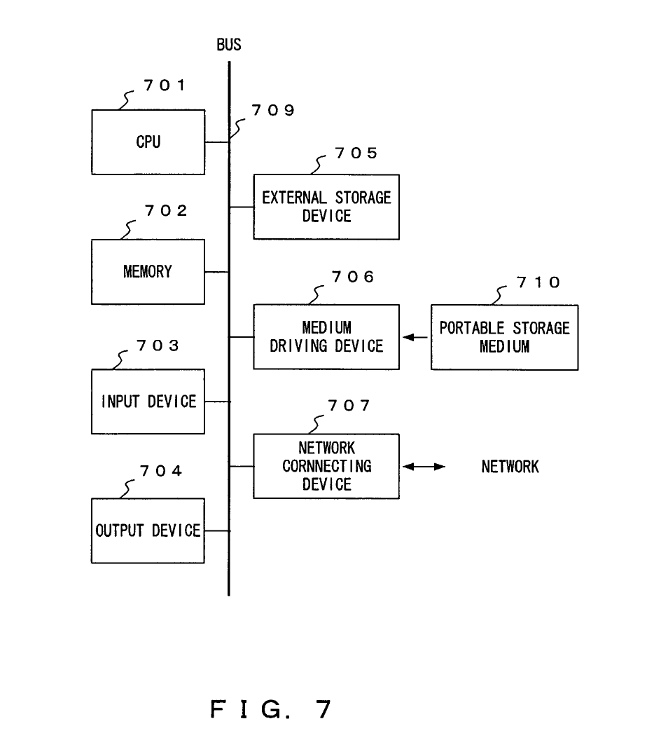

Additionally, as shown in FIG. 7, the vehicle allocating system can be implemented also by a system that is configured by a CPU 701, a memory 702 such as a ROM or a RAM, an input device 703, an output device 704, an external storage device 705, a medium driving device 706, a portable storage medium 710, and a network connecting device 707, which are connected to a bus 709. Namely, the memory 702 such as the ROM or the RAM, the external storage device 705, or the portable storage medium 710, which stores the program code of software which implements the system according to the above described preferred embodiment, is provided to the vehicle allocating system, and a computer of the vehicle allocating system reads and executes the program code, whereby the vehicle allocating system is implemented as a matter of course.

In this case, the program code itself read from the portable storage medium 710, etc. implements the new functions of the present invention, and the portable storage medium 710, etc., which stores the program code, configure the present invention.

As the portable storage medium 710 for providing the program code, for example, a flexible disk, a hard disk, an optical disk, a magneto-optical disk, a CD-ROM, a CD-R, a DVD-ROM, a DVD-RAM, a magnetic tape, a nonvolatile memory card, a ROM card, a variety of storage media recorded via the network connecting device 707 (in other words, a communications line) of e-mail, a personal computer communication, etc., or the like are available.

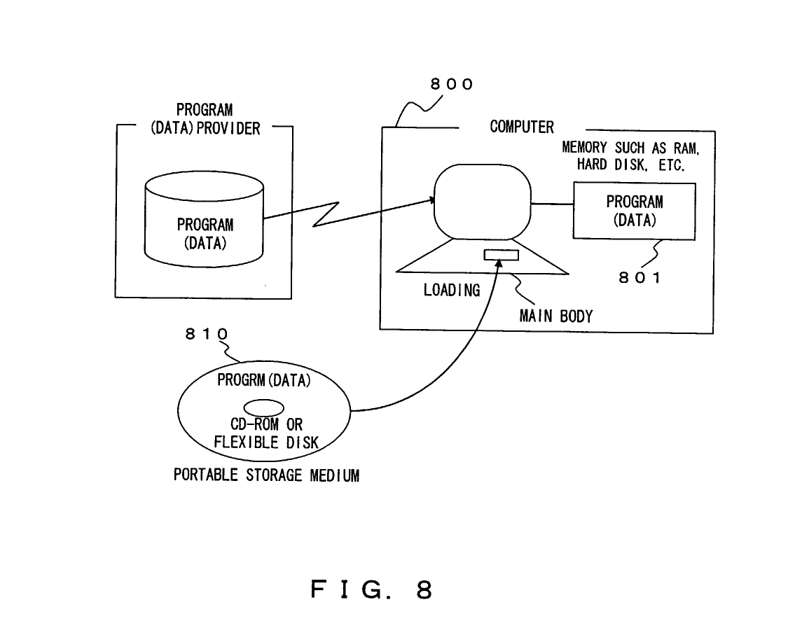

Additionally, as shown in FIG. 8, a computer 800 executes the program code which is loaded into a memory 801, so that the functions of the above described preferred embodiment can be implemented. In addition, an OS which is running on the computer 800 performs part or the whole of actual processes based on the instructions of the program code, whereby the functions of the above described preferred embodiment can be also implemented also with these processes.

Furthermore, after the program code read from a portable storage medium 810, or a program (data) provided from a program (data) provider is written to the memory 801 comprised by a function expansion board inserted into the computer 800 or a function expansion unit connected to the computer 800, a CPU, etc. comprised by the function expansion board or the function expansion unit performs part or the whole of actual processes based on the instructions of the program code, whereby the functions of the above described preferred embodiment can be implemented also with these processes.

That is, the present invention is not limited to the above described preferred embodiment, and can take a variety of configurations or forms within the scope which does not deviate from the gist of the present invention.

As described above, according to the present invention, the vehicle allocating system required to appropriately allocate a vehicle according to weather conditions can be implemented.

Furthermore, according to the present invention, a service rendered to a user can be improved by varying a fare according to weather conditions, thereby differentiating from a different company.

What is claimed is:

1. A vehicle allocating method executed by a vehicle allocating system, which is connected to a population density degree information management terminal and a weather information management terminal via a network, and optimally allocates a vehicle, comprising:
obtaining population density degree information, which indicates a number of people staying in an area peripheral to an arbitrary point, from the population density degree information management terminal;
obtaining weather information at a certain time and weather information at the certain time, which is forecast in the past, of the peripheral area from the weather information management terminal; and
determining allocation of the vehicle to the point based on the obtained population density degree information, the obtained weather information at the certain time, and the weather information at the certain time, which is forecast in the past.

2. The vehicle allocating method according to claim 1, wherein
vehicle allocation is determined so that a number of allocated vehicles is according to a product of a degree that obtained weather information at a certain time is worse than obtained weather information at the certain time is forecast in the past and a value of obtained population density degree information.

3. The vehicle allocating method according to claim 1, wherein:
vehicle use information, which indicates an amount of time that the vehicle requires to arrive at the point, is obtained from a vehicle terminal comprised by the vehicle via the network; and
vehicle allocation is determined so that the vehicle is allocated in consideration of the obtained vehicle use information.

4. The vehicle allocating method according to claim 2, wherein
vehicle use information, which indicates an amount of time that the vehicle requires to arrive at the point, is obtained from a vehicle terminal comprised by the vehicle via the network; and
vehicle allocation is determined so that the vehicle is allocated in consideration of the obtained vehicle use information.

5. The vehicle allocating method according to claim 1, wherein in said obtaining of the population density degree information:
the number of people staying in the area peripheral to an arbitrary station is predicted based on a number of people who exit through an automatic ticket gate of the arbitrary station for a predetermined time period, and a predicted number of people is obtained as population density degree information;
a number of people who exit through an automatic ticket gate of an arbitrary station for a predetermined time period is predicted based on a number of people who enter through an automatic ticket gate of a different station other than the arbitrary station by using a recording medium which records a ticket attribute, and the ticket attribute, the number of people staying in the area peripheral to the arbitrary station is predicted based on the predicted number of people who exit through the automatic ticket gate, and a predicted number of people staying in the peripheral area is obtained as population density degree information;
a number of people staying in an area peripheral to an arbitrary base station is predicted based on a number of correspondents who make a communication within the arbitrary base station for a predetermined time period, and a predicted number of people is obtained as population density degree information; or
a number of people staying in an area peripheral to an arbitrary event site around a termination time of an event is predicted based on the termination time of the event at the arbitrary event site, and a number of spectators who gather for the event, and a predicted number of people is obtained as population density degree information.

6. The vehicle allocating method according to claim 2, wherein in said obtaining of the population density degree information:
the number of people staying in the area peripheral to an arbitrary station is predicted based on a number of people who exit through an automatic ticket gate of the arbitrary station for a predetermined time period, and a predicted number of people is obtained as population density degree information;
a number of people who exit through an automatic ticket gate of an arbitrary station for a predetermined time period is predicted based on a number of people who enter through an automatic ticket gate of a different station other than the arbitrary station by using a recording medium which records a ticket attribute, and the ticket attribute, the number of people staying in the area peripheral to the arbitrary station is predicted based on the predicted number of people who exit through the automatic ticket gate, and a predicted number of people staying in the peripheral area is obtained as population density degree information;
a number of people staying in an area peripheral to an arbitrary base station is predicted based on a number of correspondents who make a communication within the arbitrary base station for a predetermined time period, and a predicted number of people is obtained as population density degree information; or
a number of people staying in an area peripheral to an arbitrary event site around a termination time of an event is predicted based on the termination time of the event at the arbitrary event site, and a number of spectators who gather for the event, and a predicted number of people is obtained as population density degree information.

7. The vehicle allocating method according to claim 3, wherein in said obtaining of the population density degree information:
the number of people staying in the area peripheral to an arbitrary station is predicted based on a number of people who exit through an automatic ticket gate of the arbitrary station for a predetermined time period, and a predicted number of people is obtained as population density degree information;
a number of people who exit through an automatic ticket gate of an arbitrary station for a predetermined time period is predicted based on a number of people who enter through an automatic ticket gate of a different station other than the arbitrary station by using a recording medium which records a ticket attribute, and the ticket attribute, the number of people staying in the area peripheral to the arbitrary station is predicted based on the predicted number of people who exit through the automatic ticket gate, and a predicted number of people staying in the peripheral area is obtained as population density degree information;
a number of people staying in an area peripheral to an arbitrary base station is predicted based on a number of correspondents who make a communication within the arbitrary base station for a predetermined time period, and a predicted number of people is obtained as population density degree information; or
a number of people staying in an area peripheral to an arbitrary event site around a termination time of an event is predicted based on the termination time of the event at the arbitrary event site, and a number of spectators who gather for the event, and a predicted number of people is obtained as population density degree information.

8. The vehicle allocating method according to claim 4, wherein in said obtaining of the population density degree information:
the number of people staying in the area peripheral to an arbitrary station is predicted based on a number of people who exit through an automatic ticket gate of the arbitrary station for a predetermined time period, and a predicted number of people is obtained as population density degree information;
a number of people who exit through an automatic ticket gate of an arbitrary station for a predetermined time period is predicted based on a number of people who enter through an automatic ticket gate of a different station other than the arbitrary station by using a recording medium which records a ticket attribute, and the ticket attribute, the number of people staying in the area peripheral to the arbitrary station is predicted based on the predicted number of people who exit through the automatic ticket gate, and a predicted number of people staying in the peripheral area is obtained as population density degree information;
a number of people staying in an area peripheral to an arbitrary base station is predicted based on a number of correspondents who make a communication within the arbitrary base station for a predetermined time period, and a predicted number of people is obtained as population density degree information; or
a number of people staying in an area peripheral to an arbitrary event site around a termination time of an event is predicted based on the termination time of the event at the arbitrary event site, and a number of spectators who gather for the event, and a predicted number of people is obtained as population density degree information.

9. The vehicle allocating method according to claim 1, wherein
determined vehicle allocation information is transmitted to the vehicle terminal.

10. The vehicle allocating method according to claim 2, wherein
determined vehicle allocation information is transmitted to the vehicle terminal.

11. The vehicle allocating method according to claim 3, wherein
determined vehicle allocation information is transmitted to the vehicle terminal.

12. The vehicle allocating method according to claim 4, wherein
determined vehicle allocation information is transmitted to the vehicle terminal.

13. The vehicle allocating method according to claim 5, wherein
determined vehicle allocation information is transmitted to the vehicle terminal.

14. The vehicle allocating method according to claim 6, wherein
determined vehicle allocation information is transmitted to the vehicle terminal.

15. The vehicle allocating method according to claim 7, wherein
determined vehicle allocation information is transmitted to the vehicle terminal.

16. The vehicle allocating method according to claim 8, wherein
determined vehicle allocation information is transmitted to the vehicle terminal.

17. The vehicle allocating method according to claim 9, wherein
a transmission of the vehicle allocation information is implemented by transmitting a fare from the point to a different point, and weather information at an arrival time of the different point.

18. A vehicle allocating system, which is connected to a population density degree information management terminal and a weather information management terminal via a network, and optimally allocates a vehicle, comprising:
a population density degree information obtaining unit obtaining population density degree information, which indicates a number of people staying in an area peripheral to an arbitrary point, from the population density degree information management terminal;
a weather information obtaining unit obtaining weather information at a certain time, and weather information at the certain time, which is forecast in the past, of the peripheral area from the weather information management terminal; and
a vehicle allocation determining unit determining allocation of the vehicle to the point based on the population density degree information obtained by said population density degree information obtaining unit, and the weather information at the certain time and the weather information at the certain time forecast in the past, which are obtained by said weather information obtaining unit.

19. A vehicle allocating program executed by a vehicle allocating system, which is connected to a population density degree information management terminal and a weather information management terminal via a network, and optimally allocates a vehicle, comprising:
obtaining population density degree information, which indicates a number of people staying in an area peripheral to an arbitrary point, from the population density degree information management terminal;
obtaining weather information at a certain time, and weather information at the certain time, which is forecast in the past, of the peripheral area from the weather information management terminal; and
determining the vehicle to the point based on the obtained population density degree information, the obtained weather information at the certain time, and the weather information at the certain time, which is forecast in the past.

20. A vehicle allocating system, which is connected to a population density degree information management terminal and a weather information management terminal via a network, and optimally allocates a vehicle, comprising:
population density degree information obtaining means for obtaining population density degree information, which indicates a number of people staying in an area peripheral to an arbitrary point, from the population density degree information management terminal;
weather information obtaining means for obtaining weather information at a certain time, and weather information at the certain time, which is forecast in the past, of the peripheral area from the weather information management terminal; and
vehicle allocation determining means for determining allocation of the vehicle to the point based on the population density degree information obtained by said population density degree information obtaining means, and the weather information at the certain time and the weather information at the certain time forecast in the past, which are obtained by said weather information obtaining means.
